(19) United States
(12) Patent Application Publication
(10) Pub. No.: US 2026/0162841 A1
(43) Pub. Date: Jun. 11, 2026

(54) CONVERSION OF SPENT NUCLEAR FUEL TO FLUORIDE SALT FUEL FOR MOLTEN SALT REACTORS

(71) Applicant: Board of Regents, The University of Texas System, Austin, TX (US)

(72) Inventors: Derek Haas, Austin, TX (US); Bradley Gladden, Austin, TX (US)

(21) Appl. No.: 19/180,473

(22) Filed: Apr. 16, 2025

Related U.S. Application Data
(60) Provisional application No. 63/670,012, filed on Jul. 11, 2024.

(51) Int. Cl. G21C 19/48; G21C 19/02; G21C 19/36

(52) U.S. Cl. CPC G21C 19/48; G21C 19/02; G21C 19/36

(57) ABSTRACT

The present invention is directed towards systems and methods for converting spent nuclear fuel (SNF) to fluoride salt fuel for use in a molten salt reactor. By utilizing nitrogen trifluoride, the entire content of a SNF solution may be fluorinated and oxidized, such that it is fit for inclusion in a molten salt reactor system. This process avoids drawbacks of traditional reprocessing since separation is avoided. The present invention utilizes a fuel conversion setup to maintain precise thermal conditions to cause fluorination of the constituents of the SNF while minimizing or avoiding volatilization.

### RELATED APPLICATIONS

The present application relates and claims priority to U.S. Provisional Application No. 63/670,012, filed on Jul. 11, 2024, which is hereby incorporated by reference in its entirety.

### TECHNICAL FIELD

The present application generally relates to methods, devices, and systems for converting spent nuclear fuel to a molten fuel salt useable in a molten salt reactor system. More specifically, to methods, devices, and systems for direct fluorination and oxidation of the entire content of nuclear waste with a fluorinating agent such that it can be used to refuel a molten salt reactor system.

### BACKGROUND

A light-water reactor (LWR) is a class of nuclear fission reactors that utilize water as the coolant and neutron moderator. LWR systems utilize solid fuel in the form of solid enriched uranium pellets stacked into a fuel rod. These fuel rods include uranium dioxide (UO₂) or plutonium dioxide (PuO₂) as the fissile material to drive energy production of the LWR. Over time the fuel rods become spent and must be replaced. The spent fuel rods are radioactive and include small amounts of fissile material and other fission products consequence of fission reactions. This poses several issues when storing and disposing of this now highly radioactive waste, which is one of the primary challenges for large-scale deployment of nuclear energy.

The nuclear industry gained familiarity with molten salt reactors following the June 1965 startup of the Oak Ridge National Laboratory (ORNL) Molten Salt Reactor Experiment (MSRE). The ORNL MSRE design incorporated a one-region reactor with graphite moderator and circulating fuel. The moderator consisted of vertical stringers of graphite, which formed a cylindrical core within a reactor vessel. The fuel passed downward in an annulus between the graphite cylinder and the core barrel. It then flowed upward in channels formed between the stringers, out the top to a pump, through a heat exchanger, and back to the core. Exiting at nearly 663° C. the fuel entered a sump-type fuel pump and was discharged through the shell side of the heat exchanger back to the core inlet. The MSRE operated for a period of four years.

A molten salt reactor (MSR) is a class of nuclear fission reactors that utilize a molten salt as both the coolant and the fissile material carrier. Unlike LWR, the fissile material is dissolved within the molten salt forming a molten fuel salt, which is circulated throughout the system to facilitate energy production. The fissile material (e.g., uranisum-235) in an MSR is typically in the form of uranium tetrafluoride (UF₄) while the fissile material in a LWR is typically in the form of uranium dioxide. Notably, molten fuel salt of an MSR systems should be substantially devoid of oxygen as it can cause corrosion.

The present invention is directed to methods and systems for converting the spent nuclear fuel or nuclear waste produced by a LWR system to a useable fuel for use a MSR system. Advantageously, by converting the spent nuclear fuel into a useable molten salt fuel, the burden of disposal is obviated and a valuable product for further energy production is generated, among other advantages.

### SUMMARY OF THE INVENTION

In one example, a method for converting spent nuclear fuel to a molten fuel salt is disclosed. The method includes exposing a quantity of spent nuclear fuel to a nitrogen trifluoride gas. The method further includes heating the spent nuclear fuel and nitrogen trifluoride gas. The heating step further includes heating the spent nuclear fuel and nitrogen trifluoride gas to a plurality of temperatures corresponding to a plurality of fluorination temperatures of a plurality of constituent of the spent nuclear fuel. The heating step further includes maintaining each of the plurality of temperatures for a period of time sufficient to cause fluorination of the plurality of constituents of the spent nuclear fuel. The method further includes converting, by the heating step, the spent nuclear fuel into the molten fuel salt.

In another example, the converting step includes fluorinating and oxidizing the constituents of the spent nuclear fuel.

In another example, the spent nuclear fuel includes spent fuel rods from a light water reactor.

In another example, the plurality of constituents of the spent nuclear fuel includes fissile material and a plurality of fission products.

In another example, the plurality of constituents of the spent nuclear fuel includes uranium dioxide, plutonium dioxide, and actinide oxides.

In another example, the converting step includes removing oxygen from the constituents of the spent nuclear fuel.

In another example, the period of time sufficient to cause fluorination of the plurality of constituents of the spent nuclear fuel is about thirty minutes.

In another example, the plurality of fluorination temperatures comprises about 360° C. and about 450° C.

In another example, the plurality of temperatures is no higher than 570° C.

In yet another example, the molten fuel salt includes uranium trifluoride and plutonium trifluoride.

In one example, a method for converting nuclear waste to a usable fuel for a molten salt reactor system is disclosed. The method includes providing the nuclear waste including uranium oxides, plutonium oxides, and a plurality of actinide oxides. The method further includes exposing the nuclear waste to a mixture of nitrogen trifluoride and argon gas. The method further includes heating the nuclear waste and the mixture to a first temperature sufficient to fluorinate at least one of the plurality of actinide oxides to at least one fluorinated actinide. The method further includes heating the nuclear waste and the mixture to a second temperature sufficient to fluorinate the uranium oxides to a uranium tetrafluoride. The method further includes heating the nuclear waste and the mixture to a third temperature sufficient to fluorinate the plutonium oxides to a plutonium tetrafluoride. The second temperature and third temperature are below a volatilization temperature of uranium tetrafluoride and plutonium tetrafluoride. The method further includes generating, by the heating steps, a molten fuel salt.

In one example, the method further includes capturing volatilized uranium and plutonium and condensing the volatilized uranium and volatilized plutonium.

In another example, the method further includes adding the at least one fluorinated actinide, the uranium tetrafluoride, and the plutonium tetrafluoride to a molten salt.

In another example, the first temperature is at least 220° C., the second temperature is at least 360° C., and the third temperature is at least 450° C.

In another example, the method further includes refueling a molten salt reactor system with the molten fuel salt.

In another example, the method further includes maintaining the first temperature, second temperature, and third temperature for about thirty minutes.

In another example, the nuclear waste includes spent fuel rods from a light water reactor.

In yet another example, the method further includes grinding the spent fuel rods into a powder.

In one example a system for converting a spent nuclear fuel to a molten fuel salt is disclosed. The system includes a fuel conversion setup including an actinide glovebox configured to receive the spent nuclear fuel. The actinide glovebox is configured to shield an exterior environment from radiation emitted a from constituents of the spent nuclear fuel. The spent nuclear fuel comprises fissile material and a plurality of actinides. The fuel conversion setup is operable to introduce a mixture of nitrogen trifluoride gas and argon gas to the actinide glovebox thereby exposing the nitrogen trifluoride to the spent nuclear fuel. The system further includes a heating element operable to heat the actinide glovebox to a plurality of temperatures corresponding to a fluorination temperature of the fissile material and a fluorination temperature of at least one actinide of the plurality of actinides.

In one example, the system further includes a thermogravimetric analyzer and a differential thermal analyzer configured to monitor phase changes of the fissile material, fertile material, and the plurality of actinides. The system further includes an argon bath configured to receive a nitrogen trifluoride and generate the nitrogen trifluoride and argon gas mixture. The system further includes a nickel tube connecting the argon bath to the actinide glovebox. The system further includes a pump fluidically coupled to the argon bath and operable to pump the mixture of nitrogen trifluoride and argon gas mixture into the actinide glovebox. The fluorination temperature of the fissile material is about 360° C. and the fluorination temperature of the at least one actinide is about 220° C.

In one example, a method for converting spent nuclear fuel (SNF) to usable fuel for a molten salt reactor (MSR) is disclosed. The method includes providing an SNF composition comprising fissile material. The method further includes introducing a concentration of nitrogen trifluoride to the SNF composition. The method further includes heating the SNF composition and concentration of nitrogen trifluoride to a temperature causing the fissile material to fluorinate. The fluorination and oxidation may create fissile fluorides. The heating of the SNF composition may cause oxygen to be removed from the SNF composition.

In another example, the fissile material includes uranium and plutonium compounds.

In another example, the SNF composition further comprises fission products and actinides.

In another example, the fluorination creates plutonium tetrafluoride, uranium tetrafluoride, and/or other fluorinated actinides.

In another example, a method for converting spent nuclear fuel (SNF) to usable fuel for a molten salt reactor (MSR) is disclosed. The method includes providing a SNF composition comprising uranium dioxide and plutonium dioxide. The method further includes heating the SNF composition to a first temperature in an argon environment. The method further includes introducing a nitrogen trifluoride and argon gas solution to the SNF composition. The method further includes heating the SNF composition and nitrogen trifluoride and argon gas solution to a second temperature causing the uranium dioxide and plutonium dioxide to fluorinate. The heating of the SNF composition to the second temperature may cause oxygen to be removed from the SNF composition. The method further includes maintaining the second temperature of the SNF composition and nitrogen trifluoride and argon gas solution for a period of time, such that the uranium dioxide and plutonium dioxide are fluorinated resulting in at least the production of uranium tetrafluoride and plutonium tetrafluoride. The method further includes capturing volatilized uranium and plutonium. The method further includes condensing volatilized uranium and plutonium. The method further includes inputting the uranium tetrafluoride and plutonium tetrafluoride into an MSR system as fuel for a nuclear fission reaction.

In another example, the SNF composition further comprises actinides and fission products.

In another example, the heating of the SNF composition causes the actinides and fission products to fluorinate.

In another example, a system for converting spent nuclear fuel (SNF) to usable fuel for a molten salt reactor (MSR) is disclosed. The system may include a fuel conversion setup including an actinide glovebox or hot cell. The actinide glovebox or hot cell may be configured to receive a composition of SNF comprising fissile material. The fuel conversion setup may include at least one thermogravimetric analyzer and at least one differential thermal analyzer configured to monitor phase changes of the fissile material. The system may include a nickel tube connecting an argon bath to the actinide glovebox. A pump of the argon bath may be operable to pump a nitrogen trifluoride solution from the argon bath to the actinide glovebox. The fuel conversion setup may include means to heat the actinide glovebox to a first temperature and maintain the first temperature for a period of time causing the fissile material to fluorinate resulting in at least the production of uranium tetrafluoride and plutonium tetrafluoride.

In another example, the system for converting spent nuclear fuel to usable fuel for a molten salt reactor further comprises an MSR system including a reactor access vessel, a reactor pump, a heat exchanger, a reactor vessel, and a drain tank. The fuel conversion setup may be fluidly connected to the access vessel of the MSR system, such that fluorinated fission products and uranium tetrafluoride are input into the access vessel.

In another example, the fissile material comprises uranium and plutonium compounds.

In another example, the composition of SNF further comprises actinides and fission products.

### BRIEF DESCRIPTION OF THE FIGURES

FIG. 1 illustrates a schematic representation of an example molten salt reactor system.

FIG. 2 illustrates a functional diagram of an example fuel conversion setup.

FIG. 3 illustrates an example fuel conversion setup.

FIG. 4 illustrates a line graph of fluorination temperatures and time intervals for fluorinating actinide contents of spent nuclear fuel.

FIG. 5 illustrates a flow diagram of an example method for converting spent nuclear fuel to a molten fuel salt.

FIG. 6 illustrates a flow diagram of an example method for converting nuclear waste to a usable fuel for a molten salt reactor system.

### DESCRIPTION OF THE INVENTION

One of the primary criticisms of nuclear energy is the need to process and handle nuclear waste or spent nuclear fuel (referred to as “SNF” herein). SNF must be managed in ways which safeguard human health and minimize impact on the environment. Nuclear waste is classified depending on its level of radioactivity and the length of its half-life, ranging from low-level waste (LLW) to high-level waste (HLW). Depending on the classification, SNF must be handled differently. For example, LLW may be simply sent to a land-based disposal site. However, HLW or long-lived intermediate level waste requires robust storage procedures. Common solutions include deep geological disposal and storage ponds, but many other management options have been investigated. One attractive option is to reprocess the SNF, which entails treating the spent fuel to recover fissile fuel (e.g., U-235) remaining therein. This option has the compound benefit of reducing the amount of waste needed to be stored and providing commercial value as the fissile fuel may be used to power nuclear reaction. However, traditional nuclear reprocessing techniques involve separating waste or spent fuel from the recovered fissile material, which increases proliferation risk and increases the concentration of highly radioactive material in the resulting waste. Thus, there is a need to improve the nuclear industry by devising methods and systems for converting SNF to usable fuel for a nuclear reactor without requiring separation of the constituents of the SNF. Such an improvement leads to a reduction in the amount of nuclear waste that needs to be disposed and the creation of a commercially valuable product in the form of usable fuel.

The present disclosure is directed to systems and methods for the conversion of SNF derived from LWR (e.g., spent fuel rods) to usable fuel for an MSR system (e.g., molten fuel salt). The SNF may generally be spent fuel rods from a light water reactor. The spent fuel rods may contain fissile material (e.g., uranium-235 in the form of UO₂ and plutonium-239 in the form of PuO₂), fertile material (e.g., uranium-238), and a variety of fission products or fragments generated as a consequence of fission reactions. The fissile material, fertile material, and fission products (sometimes collectively referred to as the “constituents” of the SNF) may be in an oxide form. Fission products includes a wide variety of actinides (e.g., isotopes of neptunium, americium, curium, strontium, cesium, iodine, technetium, ruthenium, xenon, etc.). The SNF may be generally in the form of spent fuel pellets, which may be ground into a powder for the conversion process.

In order for the SNF to be useful as fuel for an MSR system, the spent fuel must be fluorinated, void of oxides, and optionally added to a molten salt (e.g., a fluoride-lithium-beryllium salt). Advantageously, by the very nature of an MSR, the converted fuel need not have its constituents separated and the entire batch may be input into the MSR system for refueling.

Fluorination, in the nuclear fuel preparation field, is typically completed utilizing hydrogen fluoride (HF). HF is typically used in the uranium enrichment process where natural uranium ore is converted into a fluoride. However, HF is highly corrosive and dangerous to work with, so it is typically only used commercially for uranium in the nuclear industry. Furthermore, HF is highly reactive and can produce uranium oxyfluorides, which is potentially harmful for MSR systems.

Fluorination is also known to be accomplished by dioxygen difluoride, commonly referred to as FOOF. FOOF is highly reactive and dangerous, causing a number of negative side effects upon contact. FOOF has been proven to fluorinate oxides at low temperatures. However, due to the high reactivity of FOOF, the compound can easily decompose and produce other, unwanted, compounds.

Other fluorination agents have been experimented with, such as potassium difluoride (KrF₂), chlorine trifluoride (ClF₃), and bromine pentafluoride (BrFs). Experiments with chlorine trifluoride resulted in a slow and inefficient fluorination process. Experiments with potassium difluoride produced similar results with further inefficiency due to potassium difluoride's tendency to decompose in solution, producing fluorides and oxyfluorides. Lastly, bromine pentafluoride proved to be an ineffective fluorinating agent as it primarily produces oxyfluorides.

The present disclosure contemplates accomplishment of the fluoridation and oxidation steps through a single reaction with nitrogen trifluoride (NF₃). Nitrogen trifluoride may be used as a fluorination and oxidation agent in the treatment of SNF, thereby fluoridating and oxidizing the entire content of the SNF such that it may be included in an MSR system for refueling. Nitrogen trifluoride is advantageous over other fluorinating agents because of its relatively low chemical toxicity, minimal room temperature reactivity hazard, and because its reactivity is more temperature dependent (i.e., thermally sensitive). In this regard, the thermal sensitivity of nitrogen trifluoride may be utilized to control the volatility of SNF constituents by utilizing lower temperatures for longer time periods. As will be understood by those having skill in the art, in order for the converted fuel to be suitable for an MSR system, it must remain in a molten or liquid form. As such, volatilization (e.g., UF₄ to UF₆) should be avoided.

A Pacific Northwest National Laboratory journal article titled “On the Use of Thermal NF₃ as the Fluorination and Oxidation Agent in Treatment of Used Nuclear Fuels (“PNNL article”) has shown promising results of nitrogen trifluoride as a fluorination and oxidation agent in the treatment of SNF. The PNNL article describes an experiment where nitrogen trifluoride was used to separate constituents of SNF by leveraging the volatilization temperatures of the SNF constituents. The constituents of the SNF were heated and fluorinated using NF₃ to volatilize the fission products and actinides from the uranium and plutonium within the SNF. This process may generally be caused by the reaction below.

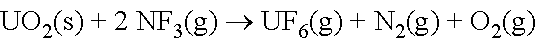

The intent of the experiment was to separate the fuel through volatilization with a fluorinating agent. This resulted in the final composition, following fluorination, containing oxyfluorides, as some isotopes of the SNF did not fully fluorinate. The uranium volatilized out of the mixture in the form of uranium hexafluoride.

The experiment of the PNNL article describes reaction conditions for separating components of SNF through volatilization by fluorination (i.e., fluoride volatility). In this regard, a mixture of about 5 to about 10 volume percent of NF₃ in argon may be used to treat SNF bearing equipment. Additionally, thermogravimetric (TG) and differential thermal analyzer (DTA) devices may be used to measure the mass and phase change of the components of the SNF during conversion. The SNF may be initially heated to 400° C. in an argon environment to remove any water contained therein. A concentration of NF₃ in an argon solution (e.g., 5 to 10 vol %) is then added to the heated SNF. Different NF₃ concentrations may be used to fluorinate specific SNF components. For example, a higher concentration of NF₃ in an argon solution (e.g., 20 to 50 vol %) may be used to reduce reaction time. A temperature ramp-up process may then be conducted on the SNF to control the reaction therein. Consequently, the SNF may be heated to a target volatilization temperature. Different fluorinating temperatures may be used to volatilize specific SNF components. For example, under fluorination with NF₃, UO₂ may volatilize at 570° C., U₃O₈ at 530° C., Nb₂O₅ at 540° C., molybdenum metal at 300° C., MoO₂ at 260° C., MoO₃ at 320° C., RuO₂ at 330° C. and 500° C., TeO₂ at 260° C., and NpO₂ at 550° C. Importantly, the PNNL article only tested temperatures up to 600° C. and certain SNF components were found not to volatize (or incompletely volatilized) at this temperature (e.g., La₂O₃, CeO₂, Rh₂O₃, and PuO₂). Thus, temperatures above 600° C. may be required to volatilize certain SNF components with NF₃. Alternatively, temperatures below 600° C. may need to be maintained for extended periods of time to volatilize certain SNF components with NF₃.

Thus, the PNNL article demonstrates that a composition of SNF may be fluorinated and oxidized by NF₃ under certain heating conditions. Advantageously, this information may be utilized to devise a method of fluorinating SNF without causing separation (i.e., by fluorinating and avoiding volatilization), or at least minimizing separation, such that the SNF may be converted into a salt form for use in a MSR system. The present invention contemplates heating a SNF composition under specific temperature conditions for specific time intervals in order to fluorinate the constituents therein without fuel separation (e.g., through volatilization). The primary constituent of SNF, uranium dioxide (UO₂) and plutonium dioxide (PuO₂) (collectively referred to as “fissile material”), may be effectively fluorinated to form uranium tetrafluoride by using NF₃ as the fluorinating and oxidizing agent. Such fluorinated forms may be added to a molten salt (e.g., FLiBe) and input into an MSR system to refuel it. Additionally, the fissile material may unintentionally volatilize. In such a case, the present invention contemplates condensing the volatilized fissile material back into a liquid form (e.g., uranium hexafluoride into uranium tetrafluoride), thus avoiding separation.

NF₃ may be utilized as a fluorinating and oxidizing agent to convert an SNF composition into a salt form for use in an MSR system. In this regard, NF₃, under specific heating conditions, may be exposed to a quantity of SNF to remove oxygen and transform the previous oxides into fluorides. NF₃ may be added to a SNF composition (i.e., without the need for separation) and heated to fluorinate and oxidize the entire content of the SNF, notably converting UO₂ to UF₄ and PuO₂ to PuF₄, in a single reaction step. One of ordinary skill in the art will appreciate that the complete SNF composition will include other components, such as fission products and other actinides, and appreciate that these two will be fluorinated, oxidized, optionally condensed, and included in the MSR system.

This process may generally be caused by the reaction below.

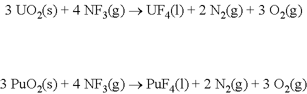

By utilizing NF₃ under specific heating conditions a composition of SNF may be converted into fuel in a salt form fit for use in an MSR system. In several embodiments, the NF₃ is in an argon gas solution prior to addition to the SNF composition.

In contrast to the experiment conduct in the PNNL article, which aimed to separate constituents of SNF through volatilization, the present invention maintains a lower temperature for a longer period of time to cause fluorination, minimize or eliminate volatilization, and avoid separation. Due to the nature of an MSR system, fuel must eventually be in a liquid or molten form and be devoid of oxygen. Advantageously, due to the high temperature and uniform fuel dissolution an MSR system does not require pure fissile material as fuel and can handle fuel containing fission products or other actinides. While this may decrease the efficiency of the resulting converted molten fuel salt, value is still obtained because the SNF need not be stored or processed, and fuel is created for the MSR system. Other benefits include a reduction of proliferation risk of traditional reprocessing methods and use for SNF, as opposed to long-term storage. Further benefits include transforming long-lived nuclear waste into short-lived nuclear waste, consequence of neutron bombardment within the MSR system (i.e., increasing exposure to neutrons to transmute the long-lived radionuclides into shorter-lived radionuclides).

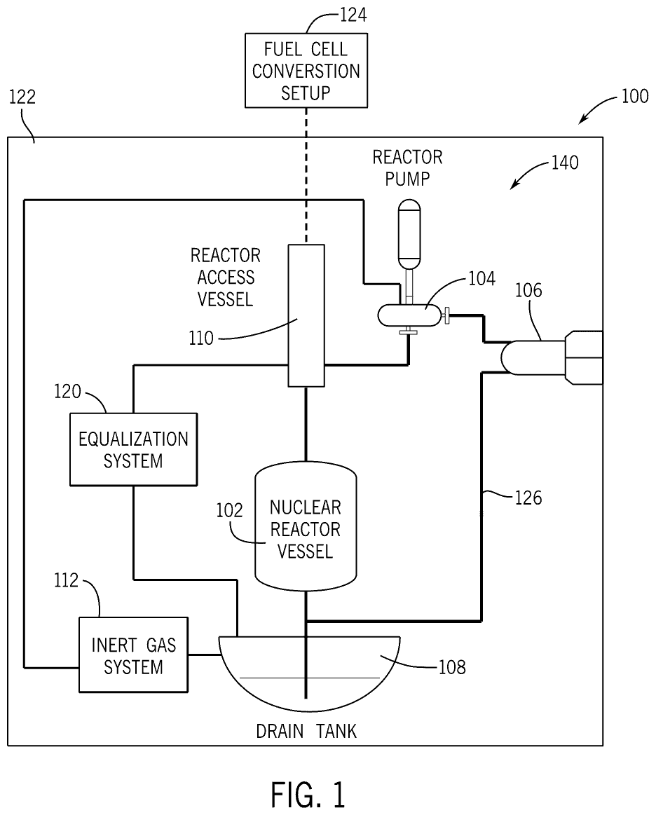

Turning now to FIG. 1, which illustrates a schematic representation of an example molten salt reactor system 100 to which the converted fuel may be used to refuel. In one example, molten salt reactor system 100 utilizes a molten salt with enriched uranium (e.g., high-assay low-enriched uranium) dissolved therein and configured to create thermal power via nuclear fission reactions. The composition of the fuel salt may be LiF—BeF₂—UF₄, though other compositions of fuel salts may be utilized as fuel salts within the reactor system 100 (e.g., chloride-based salt). The fuel salt within the system 100 is heated to high temperatures (about 700° C.) and melts as the system 100 is heated. In one example, the molten salt reactor system 100 includes a reactor vessel 102 housing a reactor core configured to facilitate or otherwise cause the fission reactions to occur, a fuel salt pump 104 configured to pump the molten fuel salt throughout the system, such that the molten fuel salt re-enters the reactor vessel 102 after flowing through the heat exchanger 106, and piping in between each component 126, thereby establishing a molten salt loop. The molten salt reactor system 100 may also include additional components, such as, but not limited to, drain tank 108 and reactor access vessel 110. The drain tank 108 may be configured to store the fuel salt once the fuel salt is in the reactor system 100 but in a subcritical state, and also act as storage for the fuel salt if power is lost in the system 100. The reactor access vessel 110 may be configured to allow for introduction of small pellets of fissile material (e.g., uranium or plutonium) or beryllium into the MSR system 100 as necessary to bring the reactor to a critical state and compensate for depletion of fissile material or otherwise balance the chemistry of the molten fuel salt.

The molten salt reactor system 100 may further include an inert gas system 112 to provide inert gas (e.g., nitrogen) to a head space of the drain tank 108, among other functions. The inert gas system 112 may further relieve inert gas from the headspace of the drain tank 108 as needed. The inert gas system 112 is therefore operable to maintain pressurized inert gas in the headspace of the drain tank 108 that is sufficient to substantially prevent the flow of molten fuel salt into the drain tank during normal operations. In one example, the inert gas system 112 is operable to maintain a pressure below atmospheric pressure within the headspace. For example, with the headspace of the drain tank 108 pressurized by the inert gas system 112, molten fuel salt may generally circulate between the reactor vessel 102 and the primary heat exchanger 106 without substantially draining into the drain tank 108. In some cases, the inert gas system 112 may be configured to supply inert gas to the headspace of various other components of the molten salt reactor system 100, such as to the headspace of the reactor access vessel 110, to the seal of reactor pump 104, among other components. Upon the occurrence of a shutdown event, the inert gas system 112 may cease providing inert gas to the head space of the drain tank 108, and other components to which the system 112 supplies inert gas. Consequently, this causes the pressure of the headspace of the drain tank 108 to decrease, which causes the fuel salt to gravitationally drain to the drain tank 108, which may be disposed at a lowermost section of the MSR system 100. Advantageously, in the event of a loss of power, emergency situation, or other failure event, the inert gas system 112 may allow the fuel salt to drain into the drain tank 108 rather than circulating to the reactor vessel 102, passively, thereby potentially avoiding pressure build up during such loss of power or other failure event.

The molten salt reactor system 100 may further include an equalization system 120 to work in conjunction with the inert gas system 112. The equalization system 120 is operable to equalize the pressure between the headspace of the drain tank 108 and the reactor vessel 102 upon the occurrence of a shutdown event. In this regard, the equalization system 120 may be operable to fluidically couple (via opening one or more valves) the head space of the drain tank 108 and the reactor vessel 102 to reduce or eliminate the pressure differential, thereby allowing the fuel salt to readily flow into the drain tank upon the shutdown event as described with reference to the inert gas system 112.

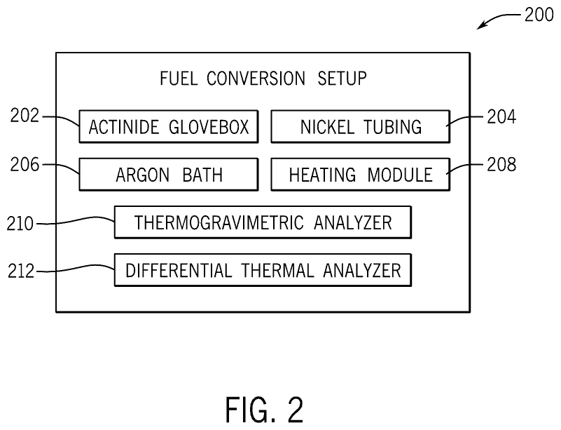

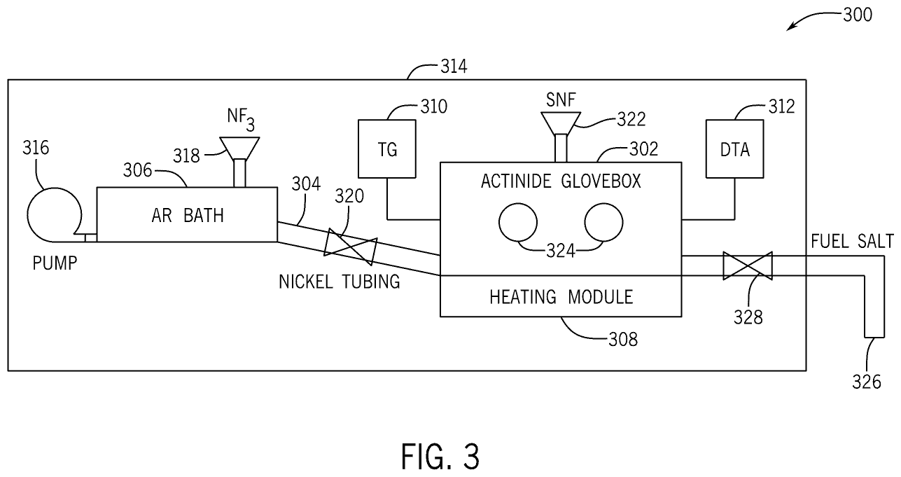

MSR system 100 may further include or be connected to a fuel cell conversion setup 124, which may be (as will be discussed in greater detail with reference to FIGS. 2 and 3) operable to convert SNF to usable fuel for the MSR system 100. The fuel cell conversion setup 124 may be fluidly connected to the access vessel 110 in order to input the converted fuel into the molten salt loop of the MSR 100, thus refueling the MSR system 100. In several embodiments, the fuel cell conversion setup 124 is operable to effectuate the conversion of SNF into usable fuel for the MSR system 100 (i.e., molten fuel salt) as described herein.

In one example, the converted fuel of the present disclosure may be input into the MSR system 100 via the reactor access vessel 110. In this regard, a fuel conversion setup 124 may be at least indirectly connected to the reactor access vessel 110, such that converted fuel may be input into the reactor access vessel 110 and into the molten salt loop of MSR system 100. In one example, the fuel conversion setup 124, may be directly coupled to the reactor access vessel 110 such that the converted fuel may be directly input into the reactor access vessel 110 (e.g., via direct piping connection). In another example, the fuel conversion setup 124, is indirectly coupled to the reactor access vessel 110, that is with other operating equipment (e.g., storage and transform vessels configured to contain the converted fuel) included to facilitate transfer and input.

The MSR system 100 is depicted and described herein to illustrate example process equipment with which the various conversion methods and systems of the present disclosure may be used. Accordingly, while the molten salt reactor system 100 is described herein, it will be appreciated that the converted fuel may be used in a variety of MSR systems or other systems requiring molten fuel salt. As will be understood by one of ordinary skill in the art, the example shown in FIG. 1 represents merely one example configuration of a molten salt reactor system 100 in which molten fuel salt may be prepared for following reprocessing of SNF.

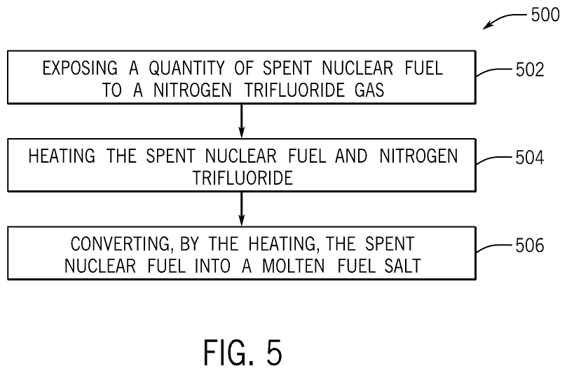

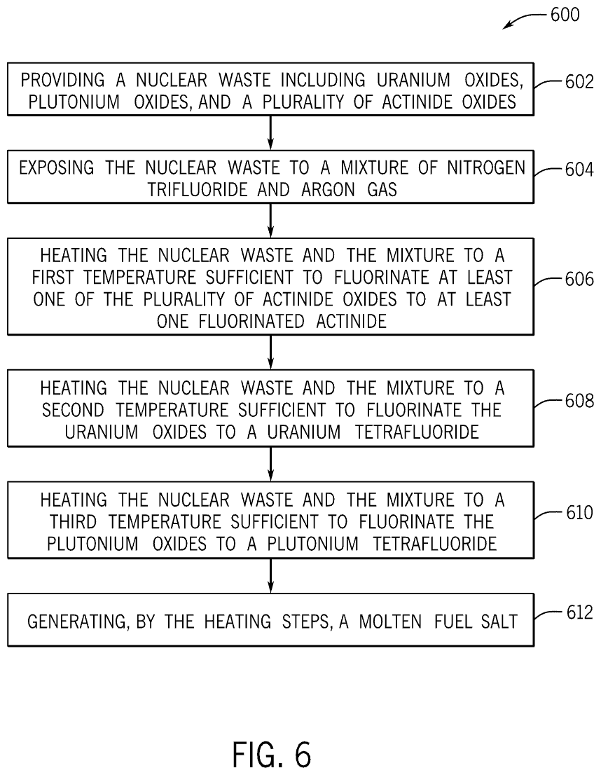

FIG. 2 illustrates a functional diagram of a fuel conversion setup 200. For clarity, the fuel cell conversion setup 200 may be a collection of experimental equipment used to facilitate the methods and process steps for converting SNF to a useable molten fuel salt as described herein. While the fuel conversion setup 200 includes specific function equipment, one of ordinary skill in the art will appreciate that it may include additional experimental equipment not specifically mentioned herein. The fuel conversion setup 200 may be operable to convert SNF to usable fuel for an MSR system (e.g., MSR system 100) by fluorinating and oxidizing the entire content of the SNF with a fluorinating agent (e.g., NF₃). The fuel conversion setup 200 may be operable to facilitate the steps of the methods described herein. For example, the fuel conversion setup 200 may be operable to receive SNF from a light water reactor in the form of fuel rods or uranium pellets and convert such SNF into usable fuel for a MSR system by fluorinating and oxidizing the entire content therein. The fuel conversion setup 200 may be operable to facilitate the steps described with references to FIGS. 5 and 6.

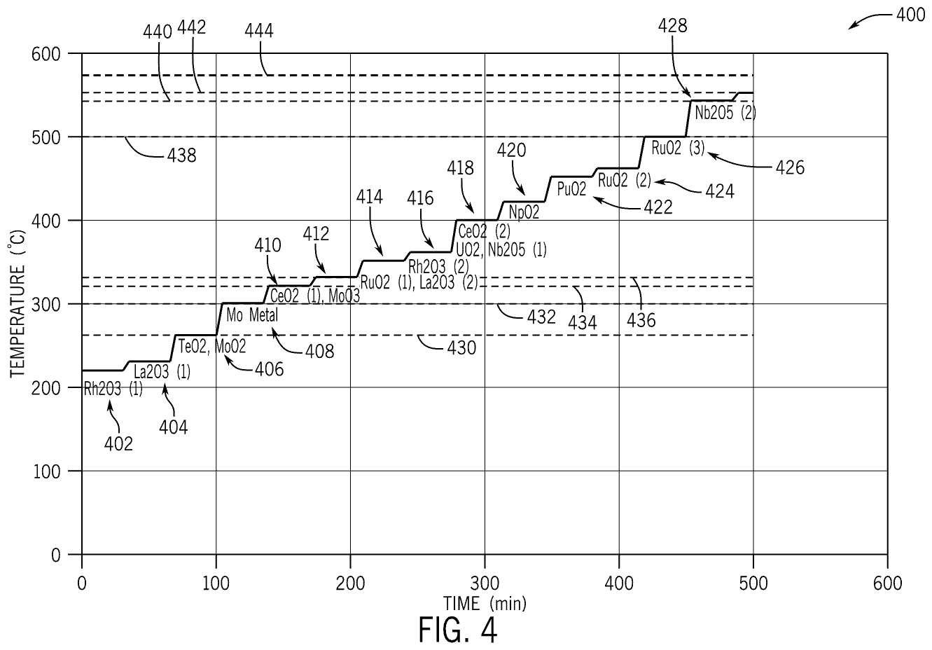

In several embodiments, the fuel conversion setup 200 includes an actinide glovebox 202, nickel tubing 204, an argon bath 206, a heating module 208, a thermogravimetric analyzer 210, and/or a differential thermal analyzer 212. The actinide glovebox 202 may be generally operable to receive SNF and facilitate its conversion to fluoride salt fuel for an MSR system by heating the SNF with a fluorinating agent (e.g., NF₃). In several embodiments the actinide glovebox is a hot cell or includes a hot cell therein. For the sake of clarity, the containment component holding the SNF is referred to as a glovebox but may be replaced with or include a hot cell. The argon bath 206 may be generally operable to store argon gas and receive a concentration of nitrogen trifluoride, in order to dilute a concentration of nitrogen trifluoride prior to introduction to the SNF. The actinide glovebox 202 and argon bath 206 may be fluidly connected by nickel tubing 204 configured to transfer contents of the argon bath 206 (e.g., a nitrogen trifluoride and argon gas solution or pure argon gas) to the actinide glovebox 202. The heating module 208 may be functionally connected to the actinide glovebox 202, such that it is operable to heat the contents of the actinide glovebox 202 (e.g., a SNF, nitrogen trifluoride, and argon gas mixture) to specific temperatures for specific time intervals. For example, the heating module 208 may be configured to heat the SNF composition to the temperatures and for the time intervals outlined with respect to FIG. 4. The fuel conversion setup 200 may further include or be functionally connected to a thermogravimetric analyzer 210 generally configured to analyze phase changes, such as those occurring in the SNF composition during heating by the heating module 208. The fuel conversion setup 200 may also include or be functionally connected to a differential thermal analyzer 212, which may be generally operable to monitor thermal and reaction velocity measurements. The thermogravimetric analyzer 210 and differential thermal analyzer 212 may cooperatively function to provide analysis and monitor the volatility of components within the SNF composition (e.g., uranium compounds, plutonium compounds, fission products, and other actinides).

FIG. 3 illustrates an example fuel conversion setup 300. The fuel conversion setup 300 may be operable to convert SNF to usable fuel for an MSR system (e.g., MSR system 100) by fluorinating and oxidizing the entire content of the SNF with a fluorinating agent (e.g., NF₃) while maintaining a liquid state (i.e., minimizing volatilization). For clarity, the example fuel conversion setup 300 may be a lab or experimental setup composed of certain process equipment operable to facilitate the process steps described herein. The example fuel conversion setup 300 may be substantially analogous to the fuel conversion setup 200 and include an actinide glovebox 302, nickel tubing 304, an argon bath 306, a heating module 308, a thermogravimetric analyzer 310, and a differential thermal analyzer 312. In several embodiments, the actinide glovebox 302 is replaced with or includes a hot cell.

However, FIG. 3 highlights other components that may be included for preparing fuel salt for input into an MSR system. For example, the fuel conversion setup 300 may include an outer wall 314 to container components therein. For clarity, the outer wall 314 may be the walls of a lab room, a container wall, or any general enclosure housing the components therein. The outer wall 314 may be a stainless-steel enclosure. The argon bath 306 may be equipped with a pump 316 and an intake 318. The pump 316 may be configured to direct or pump gas from the argon bath (e.g., argon gas) through the nickel tubing and into the actinide glovebox 302. The intake 318 may be configured to facilitate input of a fluorinating agent (e.g., NF₃) into the argon bath 306. Collectively, the argon bath 306, intake 318, pump 316, and nickel tubing 304 may be configured to introduce a concentration of a fluorinating agent (e.g., NF₃) diluted in an inert gas (e.g., argon gas) into the actinide glovebox 302 to facilitate fluorination and oxidation of the entire content of SNF. The nickel tubing 304 may include a valve 320 to fluidly connect or isolate the argon bath 306 from the actinide glovebox 302. The actinide glovebox 302 may be functionally connected to the heating module 308, such that the heating module 308 may heat the contents of the actinide glovebox 302. The actinide glovebox 302 may be in functional communication with the thermogravimetric analyzer 310 and differential thermal analyzer 312, such that they may measure phase changes occurring within the glovebox 302. For example, thermogravimetric analyzer 310 and differential thermal analyzer 312 may be operable to determine volatility, temperature, and reaction velocity measurements of the SNF. The actinide glovebox 302 may further include an intake 322 configured to introduce a sample of SNF into the glovebox 302. The actinide glovebox 302 may further include a pair of glove inputs 324 built into the glovebox 302 and arranged such that an operator can place their hands into the glove inputs 324 and perform tasks within the glovebox 302 while being protected from the contents therein. Collectively, the actinide glovebox 302, heating module 308, thermogravimetric analyzer 310, differential thermal analyzer 312, and input 322 may be configured to facilitate conversion of a sample of SNF to usable fuel for a molten salt reactor by facilitating fluorination and oxidation of the entire content of the SNF. The collective components may facilitate heating of the SNF and NF₃ in an argon environment for specific time intervals in order to fluorinate the entire content of the SNF while avoiding fuel separation (i.e., reprocessing). For example, by utilizing the temperatures and time periods disclosed with reference to FIG. 4. The actinide glovebox 302 may be fluidly connected to a fuel salt output 326 that penetrates the outer wall 314 and is equipped with a valve 328, such that following conversion (i.e., conversion of SNF to usable fuel for an MSR system) the fuel salt may exit the fuel conversion setup 300 for input into a MSR system (e.g., MSR system 100 of FIG. 1). Advantageously, the fuel conversion setup 300 is operable to convert a sample of SNF into usable fuel for a MSR system without requiring the separation of any fissile components (e.g., uranium and plutonium) of the SNF.

As discussed, the present disclosure is related to methods and systems for converting a quantity of SNF or nuclear waste produced by a LWR into a molten fuel salt for an MSR system. In one example, the method includes exposing the SNF to a quantity of nitrogen trifluoride gas and heating this mixture to select temperatures corresponding with fluorination temperature of the constituents of the SNF. In this regard, the mixture may be held at these select fluorination temperatures to facilitate fluorination and oxidation of the SNF constituents. The mixture may be held at these fluorination temperatures for an extended period of time (e.g., about 30-minutes) to ensure full fluorination of the particular constituent, thereafter the temperature may be increased to the next constituent fluorination temperature and held for an extended period of time. This process may continue until the entire content of the SNF has been fluorinated while ensuring the temperature does not increase at least above the volatilization temperature of the fissile material. Advantageously, the present disclosure contemplates holding the fluorination temperature for an extended period of time with minimal to no temperature increase to minimize or eliminate volatilization (at least for certain constituents).

While the PNNL article disclosed methods of separating constituents from used nuclear fuel by fluorination with NF₃ and exploiting the different volatilities of the fission products and actinide fluorides, the present invention utilizes specific temperatures under specific time intervals in order to fluorinate and oxidize the contents of a SNF sample without fuel separation. Stated otherwise, the present invention utilizes more precise heating conditions and time intervals to control the volatility of the SNF constituents. The PNNL article tested this separation technique by ramping the temperature of the SNF constituents until volatilization occurred. The system and methods described herein heat the entire SNF content under precise temperatures and associated time intervals to achieve fluorination and oxidation while minimizing or avoiding volatilization, thus obviating separation. Additionally, the present invention intentionally avoids a separation step and keeps the SNF constituents in one solution. Advantageously, molten fuel salt for an MSR system may include the fluorinated constituents of the SNF, thus obviating the need to separate. Lastly, by utilizing a fluorinating agent that is also able to oxidize the SNF constituents, resulting in removal of all oxygen within the SNF, harm to the MSR system is avoided.

Turning now to FIG. 4, illustrates a line graph 400 of fluorination temperatures and time intervals for fluorinating contents of SNF while minimizing or avoiding volatilization, thus circumventing separation. As illustrated in FIG. 4 the quantity of SNF is heated to select temperatures to cause fluorination and minimize volatilization of several constituents of the SNF. In this regard, FIG. 4 includes a plurality of temperature plateaus corresponding with fluorination temperatures of a wide variety of SNF constituents (i.e., compounds anticipated to be present in spent fuel rods from an LWR). In one example, optionally utilizing the fuel conversion set ups described with reference to FIGS. 2 and 3, a quantity of SNF (e.g., powdered spent nuclear fuel pellets) is exposed to a nitrogen trifluoride gas (optionally diluted with argon gas), this mixture is then heated, according to the temperature and time conditions illustrated in FIG. 4. As a result, the entire content of the SNF is converted into a fluoride form (e.g., UF₄), is devoid of oxygen, and fit for inclusion into an MSR system (e.g., MSR system 100 via reactor access vessel 110) for refueling, or added to a molten salt.

FIG. 4 illustrates a plurality of SNF constituents anticipated to be found in the SNF and their associated fluorination temperatures. These may generally include fissile material, fertile material, and a plurality of fission products and actinide oxides. Each of the aforementioned constituents, have a known fluorination temperature, that is, the temperature at which the compound fluorinates when exposed to NF₃ and a known volatilization temperature, that is, the temperature at which the compound volatilizes when exposed to NF₃. FIG. 4 illustrates a plurality of temperatures corresponding to a plurality of fluorination temperatures of a plurality of constituents of the SNF, that are held for a period of time to cause fluorination while avoid volatilization. As illustrated in FIG. 4, the temperature is maintained at the lowest fluorination temperature, then ramped up to the next fluorination temperature continually until the entire SNF contents are fluorinated. During this process, certain constituents, not needed for power production in an MSR, may be volatilized from the mixture.

In one example, the quantity of SNF and NF₃ is heated to a first fluorination temperatures 402 to facilitate fluorination of Rh₂O₃. In one example, first fluorination temperature 402 is about 220° C. and is maintained for about 30 minutes. In this regard, Rh₂O₃ may be converted into RhF₃. Thereafter, the quantity of SNF and NF₃ may be heated to a second fluorination temperatures 404 to facilitate fluorination of La₂O₃. In one example, second fluorination temperature 404 is about 230° C. and is maintained for about 30 minutes. In this regard, La₂O₃ may be converted into LaF₃. Thereafter, the quantity of SNF and NF₃ may be heated to a third fluorination temperatures 406 to facilitate fluorination of TeO₂ and MoO₂. In one example, third fluorination temperature 406 is about 260° C. and is maintained for about 30 minutes. In this regard, TeO₂ and MoO₂ may be converted into TeF₄ and MoF₆. In one example, third fluorination temperature 406 is held for an additional 30 minutes to volatilize MoO₂ out of the mixture. Thereafter, the quantity of SNF and NF₃ may be heated to a fourth fluorination temperatures 408 to facilitate fluorination or volatilization of molybdenum metal. In one example, fourth fluorination temperature 408 is about 300° C. and is maintained for about 30 minutes. In this regard, molybdenum metal may be converted into MoF₆ and volatilized out. Thereafter, the quantity of SNF and NF₃ may be heated to a fifth fluorination temperatures 410 to facilitate fluorination of CeO₂ and MoO₃. In one example, fifth fluorination temperature 410 is about 320° C. and is maintained for about 30 minutes. In this regard, CeO₂ may be converted into CeF₃ and MoO₃ may be converted into MoF₆ and volatilized out. Thereafter, the quantity of SNF and NF₃ may be heated to a sixth fluorination temperatures 412 to facilitate fluorination of RuO₂ and La₂O₃. In one example, sixth fluorination temperature 412 is about 330° C. and is maintained for about 30 minutes. In this regard, RuO₂ may be converted into RuF₄ and La₂O₃ may be converted into LaF₃. Thereafter, the quantity of SNF and NF₃ may be heated to a seventh fluorination temperatures 414 to facilitate fluorination of Rh₂O₃. In one example, seventh fluorination temperature 414 is about 350° C. and is maintained for about 30 minutes. In this regard, Rh₂O₃ may be converted into RhF₃. Thereafter, the quantity of SNF and NF₃ may be heated to an eighth fluorination temperatures 416 to facilitate fluorination of UO₂ and Nb₂O₅. In one example, eight fluorination temperature 416 is about 360° C. and is maintained for about 30 minutes. In this regard, UO₂ may be converted into UF₄ and Nb₂O₅ may be converted into NbF₅. Thereafter, the quantity of SNF and NF₃ may be heated to a ninth fluorination temperatures 418 to facilitate fluorination of CeO₂. In one example, ninth fluorination temperature 418 is about 400° C. and is maintained for about 30 minutes. In this regard, CeO₂ may be converted into CeF₃ and/or CeF₄. Thereafter, the quantity of SNF and NF₃ may be heated to a tenth fluorination temperatures 420 to facilitate fluorination of NpO₂. In one example, tenth fluorination temperature 420 is about 420° C. and is maintained for about 30 minutes. In this regard, NpO₂ may be converted into NpF₄. Thereafter, the quantity of SNF and NF₃ may be heated to an eleventh fluorination temperatures 422 to facilitate fluorination of PuO₂. In one example, eleventh fluorination temperature 422 is about 450° C. and is maintained for about 30 minutes. In this regard, PuO₂ may be converted into PuF₄. Thereafter, the quantity of SNF and NF₃ may be heated to a twelfth fluorination temperatures 424 to facilitate fluorination of RuO₂. In one example, twelfth fluorination temperature 424 is about 500° C. and is maintained for about 30 minutes. In this regard, RuO₂ may be converted into RuF₄. Thereafter, the quantity of SNF and NF₃ may be heated to a thirteenth fluorination temperatures 426 to facilitate fluorination of RuO₂. In one example, thirteenth fluorination temperature 426 is about 540° C. and is maintained for about 30 minutes. In this regard, RuO₂ may be converted into RuF₄. As illustrated by fluorination temperature 424 and 426, certain SNF constituent may require more than one fluorination temperature to facilitate full fluorination of that particular constituent. Thereafter, the quantity of SNF and NF₃ may be heated to a fourteenth fluorination temperatures 428 to facilitate fluorination of Nb₂O₅. In one example, fourteenth fluorination temperature 42 is about 540° C. and is maintained for about 30 minutes. In this regard, Nb₂O₅ may be converted into NbF₃. Thereafter, the quantity of SNF and NF₃ may be elevated to higher temperatures but not increasing beyond 570° C. For example, the temperature may be increased to 530° C. and maintained for about thirty minutes to fluorinate U₃O₈.

In this regard, the quantity of SNF may be exposed to NF₃ under heating conditions to fluorinate and oxidize the entire contents therein. The resulting product may be added to an MSR system or added to a molten salt for refueling.

The previous examples describing holding the select fluorination temperature for about 30 minutes each. However, in other examples, the fluorination temperatures are held for a time period shorter than or longer to thirty minutes. For example, the fluorination temperatures may be held for 5 minutes, 10 minutes, 15 minutes, 25 minutes, 35 minutes, 40 minutes, 50 minutes, 1 hour, 2 hours, 3 hours, 4 hours, 5 hours, or longer. In this regard, each fluorination temperature may be held for a number of different times to facilitate fluorination.

For clarity, FIG. 4 includes several indications of different constituent volatilization temperatures, where particular constituents are anticipated to volatilize. For example, a first volatilization temperature 430 occurs at about 250° C. where Te and Mo are anticipated to volatilize. In one example, volatilization temperature 432 occurs at about 300° C. where Mo is anticipated to volatilize from Mo metal. In one example, volatilization temperature 434 occurs at about 320° C. where Mo is anticipated to volatilize from MoO₃. In one example, volatilization temperature 436 occurs at about 330° C. where Ru is anticipated to volatilize from RuO₂. In one example, volatilization temperature 438 occurs at about 500° C. where Ru is anticipated to volatilize from RuO₃ or RuO₂. In one example, volatilization temperature 440 occurs at about 540° C. where Nb is anticipated to volatilize from Nb₂O₅. In one example, volatilization temperature 442 occurs at about 550° C. where Np is anticipated to volatilize from NpO₂. In one example, volatilization temperature 444 occurs at about 570° C. where U is anticipated to volatilize, however, experimental parameters are set to avoid reaching and exceeding this temperature to ensure fissile material is not volatilized out of the resulting mixture.

During the above-described reaction parameters, the certain SNF constituents may unintentionally volatilize (e.g., fissile material). To combat this negative consequence, the present invention contemplates condensing the volatilized constituents (e.g., UF₆) back into a liquid form, so that it can be added to an MSR system. For example, the volatilized constituents may be condensed to a liquid form by condensing said volatilized species. The volatilized constituents may be condensed through the use of an air- or water-cooled heat exchanger or other means known in the art. The volatilizes constituents may be condensed through cryogenically freezing.

Turning now to FIG. 5, which illustrates an example method 500 for converting spent nuclear fuel to a molten fuel salt. At step 502, a quantity of spent nuclear fuel is provided and exposed to a nitrogen trifluoride gas. The quantity of spent nuclear fuel may include uranium oxide and other fission product oxides formed from the spent fuel rods of a light water reactor, which may then be ground into a powder for processing. The quantity of spent nuclear fuel may be provided to the actinide glovebox 302 of FIG. 3. The SNF composition may also be provided in a hot cell or in an actinide glovebox containing a hot cell. At step 504, the quantity of spent nuclear fuel and nitrogen trifluoride are heated. In one example, the nitrogen trifluoride is mixed with an argon gas solution prepared in the argon bath 306 of FIG. 3. Additionally, the pump 316 may be operable to pump the nitrogen trifluoride and argon gas solution into the actinide glovebox, thus effectuating introducing the materials together. The heating step 504 may include heating the spent nuclear fuel and nitrogen trifluoride gas to a plurality of temperatures corresponding to a plurality of fluorination temperatures of a plurality of constituent of the spent nuclear fuel. The heating step 504 may further include maintaining each of the plurality of temperatures for a period of time sufficient to cause fluorination of the plurality of constituents of the spent nuclear fuel. In one example, the heating step 504 is facilitated according to the time and temperature conditions illustrated in FIG. 4.

At step 506, the spent nuclear fuel is converted to a molten fuel salt by heating step 504. Advantageously the heating step 504 may cause the fluorination and oxidation of the entire actinide content of the SNF composition, while avoiding volatilization. The temperature of the SNF composition and nitrogen trifluoride caused by the heating step 504 may be maintained for a period of time. The temperature may be maintained for the time intervals discussed with reference to FIG. 4, such that fluorination is achieved, and volatilization is minimized or completely avoided. For example, the heating step 504 may cause the uranium dioxide to fluorinate into uranium tetrafluoride while minimizing or eliminating the production of uranium hexafluoride. Similarly, triuranium octoxide (U₃O₈) may also fluorinate and oxidize into uranium tetrafluoride. Additionally, molten salt (e.g., FLiBe) may be added to the resulting solution prior to addition to a MSR system. Following the steps illustrated in the flow diagram of FIG. 5, a composition of SNF is converted to usable fuel for a MSR system (e.g., MSR system 100) without requiring separations of constituents of the SNF composition.

Turning now to FIG. 6, which illustrates a method 600 for converting nuclear waste to a usable fuel for a molten salt reactor system. At step 602, a nuclear waste is provided. The nuclear waste may include uranium oxides, plutonium oxides, and a plurality of actinide oxides. The composition of SNF may be that of spent fuel rods from a light water reactor. At step 604, the nuclear waste is exposed to a mixture of argon gas and nitrogen trifluoride gas. The nitrogen trifluoride in argon gas solution may be prepared in the argon bath 306 of FIG. 3. Additionally, the pump 316 may be operable to pump the nitrogen trifluoride and argon gas solution into the actinide glovebox, thus effectuating introducing the materials together. At step 606 through step 608, the nuclear waste and gas mixture are heated to a plurality of different fluorination temperatures and maintained at said temperature for a period of time to cause fluorination while avoiding volatilization (at least of the fissile material constituents). Such temperatures and time periods may be those described with reference to FIG. 4. For example, the nuclear waste and gas mixture may be heated to a first temperature sufficient to fluorinate at least one of the plurality of actinide oxides to at least one fluorinated actinide. As another example, the nuclear waste and gas mixture may be heated to a second temperature sufficient to fluorinate the uranium oxides to a uranium tetrafluoride. As another example, the nuclear waste and gas mixture may be heated to a third temperature sufficient to fluorinate the plutonium oxides to a plutonium tetrafluoride. The mixture may be heated utilizing the heating module 308 FIG. 3. Such heating may occur within an actinide glovebox, an actinide glovebox containing a hot cell, or a hot cell. The heating steps 608-610 may cause the fluorination and oxidation of the entire content of the SNF composition, while minimizing or avoiding volatilization (at least of the fissile material). In one example, any unintentionally volatilized uranium compounds (e.g., uranium hexafluoride), other fission product, and actinide fluorides are captured. For example, the actinide glovebox may be equipped with a charcoal filter atop the glovebox, such that volatilized species are captured as they rise out of the glovebox. As another example, the actinide glovebox may be equipped with or functionally connected to a condenser. In this example, the actinide glovebox may be further equipped with a relief valve connecting the actinide glovebox to the condenser. In this example, the release valve may be activated allowing any unintentionally volatilized constituents to enter the condenser, where they are condensed and subsequently added back into the actinide glovebox. Advantageously, this avoids any separation of SNF constituents. The captured volatilized fissile material (e.g., uranium and plutonium compounds), fission products, and other actinides may be condensed. For example, the volatilized species captured may be condensed in a quartz optical cell. The uranium tetrafluoride and plutonium tetrafluoride may be input into an MSR system to act as fuel for fission reactions therein. Additionally, other fluorinated constituents may be input into the MSR system. For example, fluorinated actinides, fission products, plutonium (in the form of plutonium tetrafluoride) may also be input into the MSR system. However, one of ordinary skill in the art will appreciate that the end result, as described is an input of the entire fluorinated contents of the SNF composition into the MSR system due to the lack of separation occurring throughout the process. The resulting solution may be added to a molten salt for inclusion in a MSR system, such as MSR system 100.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A method for converting spent nuclear fuel to a molten fuel salt comprising:
exposing a quantity of spent nuclear fuel to a nitrogen trifluoride gas;
heating the spent nuclear fuel and nitrogen trifluoride gas;
wherein the heating step comprises heating the spent nuclear fuel and nitrogen trifluoride gas to a plurality of temperatures corresponding to a plurality of fluorination temperatures of a plurality of constituent of the spent nuclear fuel;
wherein the heating step further comprises maintaining each of the plurality of temperatures for a period of time sufficient to cause fluorination of the plurality of constituents of the spent nuclear fuel; and
converting, by the heating step, the spent nuclear fuel into the molten fuel salt.

2. The method of claim 1, wherein the converting step comprises fluorinating and oxidizing the constituents of the spent nuclear fuel.

3. The method of claim 1, wherein the spent nuclear fuel comprises spent fuel rods from a light water reactor.

4. The method of claim 1, wherein the plurality of constituents of the spent nuclear fuel comprises fissile material and a plurality of fission products.

5. The method of claim 2, wherein the plurality of constituents of the spent nuclear fuel comprises uranium dioxide, plutonium dioxide, and actinide oxides.

6. The method of claim 5, wherein the converting step comprises removing oxygen from the constituents of the spent nuclear fuel.

7. The method of claim 1, wherein the period of time sufficient to cause fluorination of the plurality of constituents of the spent nuclear fuel is about thirty minutes.

8. The method of claim 1, wherein the plurality of fluorination temperatures comprises about 360° C. and about 450° C.

9. The method of claim 1, wherein the plurality of temperatures is no higher than 570° C.

10. The method of claim 1, wherein the molten fuel salt comprises uranium trifluoride and plutonium trifluoride.

11. A method for converting nuclear waste to a usable fuel for a molten salt reactor system comprising:
providing the nuclear waste comprising uranium oxides, plutonium oxides, and a plurality of actinide oxides;
exposing the nuclear waste to a mixture of nitrogen trifluoride and argon gas;
heating the nuclear waste and the mixture to a first temperature sufficient to fluorinate at least one of the plurality of actinide oxides to at least one fluorinated actinide;
heating the nuclear waste and the mixture to a second temperature sufficient to fluorinate the uranium oxides to a uranium tetrafluoride;
heating the nuclear waste and the mixture to a third temperature sufficient to fluorinate the plutonium oxides to a plutonium tetrafluoride;
wherein the second temperature and third temperature are below a volatilization temperature of uranium tetrafluoride and plutonium tetrafluoride; and
generating, by the heating steps, a molten fuel salt.

12. The method of claim 11, further comprising capturing volatilized uranium and plutonium and condensing the volatilized uranium and volatilized plutonium.

13. The method of claim 11, further comprising adding the at least one fluorinated actinide, the uranium tetrafluoride, and the plutonium tetrafluoride to a molten salt.

14. The method of claim 11, wherein the first temperature is at least 220° C., wherein the second temperature is at least 360° C., and wherein the third temperature is at least 450° C.

15. The method of claim 11, further comprising refueling a molten salt reactor system with the molten fuel salt.

16. The method of claim 14, further comprising maintaining the first temperature, second temperature, and third temperature for about thirty minutes.

17. The method of claim 11, wherein the nuclear waste comprises spent fuel rods from a light water reactor.

18. The method of claim 17, further comprising grinding the spent fuel rods into a powder.

19. A system for converting a spent nuclear fuel to a molten fuel salt comprising:
a fuel conversion setup comprising an actinide glovebox configured to receive the spent nuclear fuel;
wherein the actinide glovebox is configured to shield an exterior environment from radiation emitted a from constituents of the spent nuclear fuel;
wherein the spent nuclear fuel comprises fissile material and a plurality of actinides;
wherein the fuel conversion setup is operable to introduce a mixture of nitrogen trifluoride gas and argon gas to the actinide glovebox thereby exposing the nitrogen trifluoride to the spent nuclear fuel; and
a heating element operable to heat the actinide glovebox to a plurality of temperatures corresponding to a fluorination temperature of the fissile material and a fluorination temperature of at least one actinide of the plurality of actinides.

20. The system of claim 19, further comprising
a thermogravimetric analyzer and a differential thermal analyzer configured to monitor phase changes of the fissile material, fertile material, and the plurality of actinides;
an argon bath configured to receive a nitrogen trifluoride and generate the nitrogen trifluoride and argon gas mixture;
a nickel tube connecting the argon bath to the actinide glovebox;
a pump fluidically coupled to the argon bath and operable to pump the mixture of nitrogen trifluoride and argon gas mixture into the actinide glovebox; and
wherein the fluorination temperature of the fissile material is about 360° C. and the fluorination temperature of the at least one actinide is about 220° C.
